(19) United States
(12) Patent Application Publication
(10) Pub. No.: US 2015/0089086 A1
(43) Pub. Date: Mar. 26, 2015

(54) A/V INFORMATION UPDATING CONTROL SYSTEM, CONTROL DEVICE AND CONTROL METHOD

(71) Applicant: Chao-Chi YANG, Kaohsiung (TW)

(72) Inventor: Chao-Chi YANG, Kaohsiung (TW)

(21) Appl. No.: 14/037,766

(22) Filed: Sep. 26, 2013

(51) Int. Cl. G06F 13/12

(52) U.S. Cl. CPC G06F 13/122
USPC 710/5

(57) ABSTRACT

An A/V information updating control system has an A/V host and a control device. The A/V host stores an A/V information. The control device is connected with multiple user-end apparatuses. The control device receives an A/V adjusting command from any one of the user-end apparatuses, and updates the A/V information of the A/V host according to the A/V adjusting command. The control device thus sends the updated A/V information to the user-end apparatuses. Hence, each user who has the user-end apparatus can review the updated A/V information in real time.

### BACKGROUND OF THE INVENTION

1. Field of the Invention

The present invention relates to an A/V (audio and video) information control system, and more particularly to an A/V information updating control system, a control device and a control method of the A/V information updating control system.

2. Description of Related Art

A conventional audiovisual entertainment equipment mainly comprises a display, a host, an amplifier, a speaker and a disk player. The host is connected with the display, the amplifier, the speaker and the disk player. For example, when a user wants to watch a movie, the user can insert a DVD in the disk player. The host can control the display to display a setting menu. The user can set up A/V (audio and video) operating information, such as sound effect, sound volume, input selection or equalizer to the host in the setting menu. However, the conventional host has disadvantages as described below.

1. When the user only wants to listen to music but does not want to watch a video, the user still has to turn on the display and set up the A/V information in the setting menu. To turn on the display is a redundant step that is very inconvenient.

2. The conventional host has a state indicator, such as a vacuum fluorescent display (VFD), for displaying the A/V information of the host. The size of the state indicator is tiny. Due to the tiny size, the A/V information cannot be completely displayed in the state indicator.

3. The display, the host, the amplifier and the disk player are each respectively controlled by a dedicated remote controller. The user can remotely control them by using the remote controllers. However, when any one of the remote controllers is lost, the user cannot remotely control the specific display, the host, the amplifier or the disk player, causing trouble in use.

4. Any user can update the A/V information of the host. As different users have different habits or preferences, the A/V information set up by the users is frequently updated. When one user updates the A/V information, other users cannot know what information has been changed or set up by the previous user. Before the other users can enjoy the entertainment equipment, they have to review the present A/V information item by item and update the A/V information by demand. Hence, the other users cannot directly use the entertainment equipment until they have updated the A/V information, thereby causing inconvenient in using the entertainment equipment.

### SUMMARY OF THE INVENTION

An object of the invention is to provide an A/V information updating control system, a control device and a control method. The control system can display complete A/V information for the users in real time, and overcome the disadvantage that the user cannot remotely control the host as long as the dedicated remote controller is lost.

The A/V information updating control system is adapted to be connected with multiple user-end apparatuses and comprises:

an A/V host storing an A/V information; and

a control device comprising:
a wireless communication unit connected with the user-end apparatuses to receive an A/V adjusting command from any one of the user-end apparatuses;
an output unit connected with the A/V host; and
a control unit connected with the wireless communication unit and the output unit, wherein the control unit receives the A/V adjusting command from the wireless communication unit, updates the A/V information of the A/V host according to the A/V adjusting command, reads the updated A/V information of the A/V host and sends the updated A/V information to the user-end apparatuses.

The control device of the invention is adapted to be connected with multiple user-end apparatuses and an A/V host and comprises:

a wireless communication unit connected with the user-end apparatuses to receive an A/V adjusting command from any one of the user-end apparatuses;

an output unit connected with the A/V host; and

a control unit connected with the wireless communication unit and the output unit, wherein the control unit receives the A/V adjusting command from the wireless communication unit, updates an A/V information stored in the A/V host according to the A/V adjusting command, reads the updated A/V information of the A/V host and sends the updated A/V information to the user-end apparatuses.

The control method of the invention comprises the steps of:

connecting a control device to an A/V host and multiple user-end apparatuses;

receiving an A/V adjusting command by the control device from any one of the user-end apparatuses;

updating an A/V information stored in the A/V host by the control device according to the A/V adjusting command;

reading the updated A/V information of the A/V host by the control device; and

sending the updated A/V information to the user-end apparatuses by the control device.

In conclusion, the user-end apparatuses can display the complete A/V information. The user who has the user-end apparatus can review the updated A/V information in real time. The user can always rapidly set up and update the A/V information to the A/V host by demand for the purpose of listening to music or watching a movie. Compared with the conventional host, the user can directly set up and review the A/V information of the A/V host without turning on the display. The conventional dedicated remote controllers are replaced with the user-end apparatuses. It is convenient to use the user-end apparatus to remotely control the A/V host.

In addition, when any user updates the A/V information to the A/V host, the A/V host sends the updated A/V information to all of the user-end apparatuses. All of the user-end apparatuses thus display the updated A/V information to the users. The users do not have to review the AV/information item by item, but can promptly update the present A/V information by demand.

### BRIEF DESCRIPTION OF THE DRAWINGS

FIG. 1 is a circuit block diagram of an embodiment of the control system of the invention;

FIG. 2 is a circuit block diagram of an embodiment of the AN host of the invention;

FIG. 3 is a circuit block diagram of an embodiment of the control device and the infrared device of the invention;

FIG. 4 is a flow chart of an embodiment of the control method of the invention;

FIG. 5 is a detailed circuit diagram of a part of the control unit of the invention;

FIGS. 5A-5E are partial circuit diagrams in FIG. 5;

FIG. 6 is a detailed circuit diagram of a part of the control unit of the invention;

FIGS. 6A-6E are partial circuit diagrams in FIG. 6;

FIG. 7 is a detailed circuit diagram of a part of the control unit of the invention;

FIGS. 7A-7E are partial circuit diagrams in FIG. 7;

FIG. 8 is a detailed circuit diagram of the storing unit of the invention;

FIGS. 8A-8E are partial circuit diagrams in FIG. 8;

FIG. 9 is a detailed circuit diagram of the output unit of the invention;

FIGS. 9A-9E are partial circuit diagrams in FIG. 9;

FIG. 10 is a detailed circuit diagram of the infrared device of the invention; and

FIGS. 10A-10F are partial circuit diagrams in FIG. 10.

### DETAILED DESCRIPTION OF THE PREFERRED EMBODIMENT

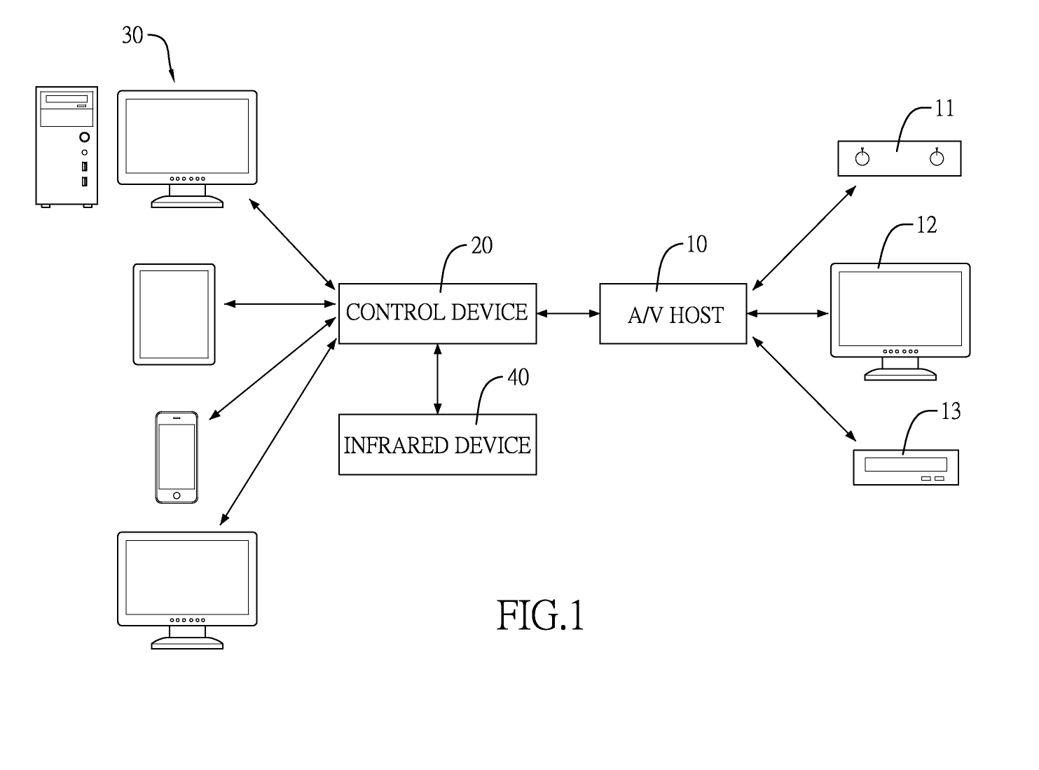

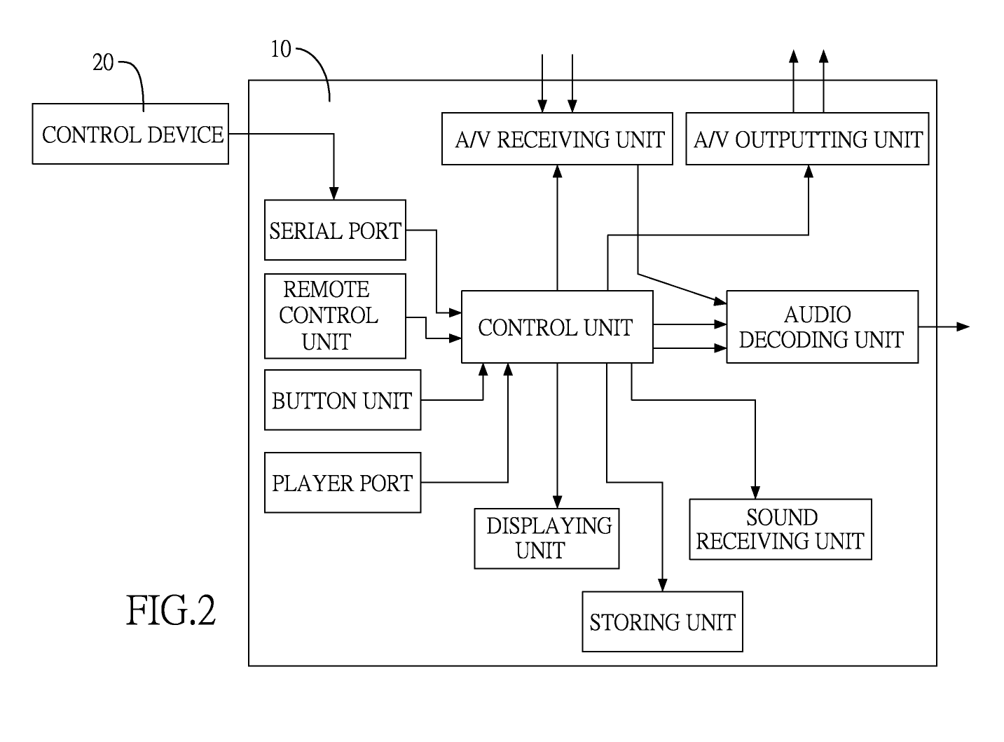

With reference to FIGS. 1 and 2, the A/V (audio and video) information updating control system of the invention comprises an A/V host 10 and a control device 20.

In this embodiment, the A/V host 10 can be, but is not limited to, an audiovisual entertainment host. The A/V host 10 is wiredly or wirelessly connected with an amplifier 11 and multiple peripheral devices, such that the A/V host 10 can wiredly or wirelessly control the amplifier 11. The peripheral devices include a display 12 and a disk player 13 as an example. The A/V host 10 stores an A/V information and controls a sound effect of the amplifier 11 according to the A/V information. For example, the A/V information includes sound tune, sound volume, equalization, etc.

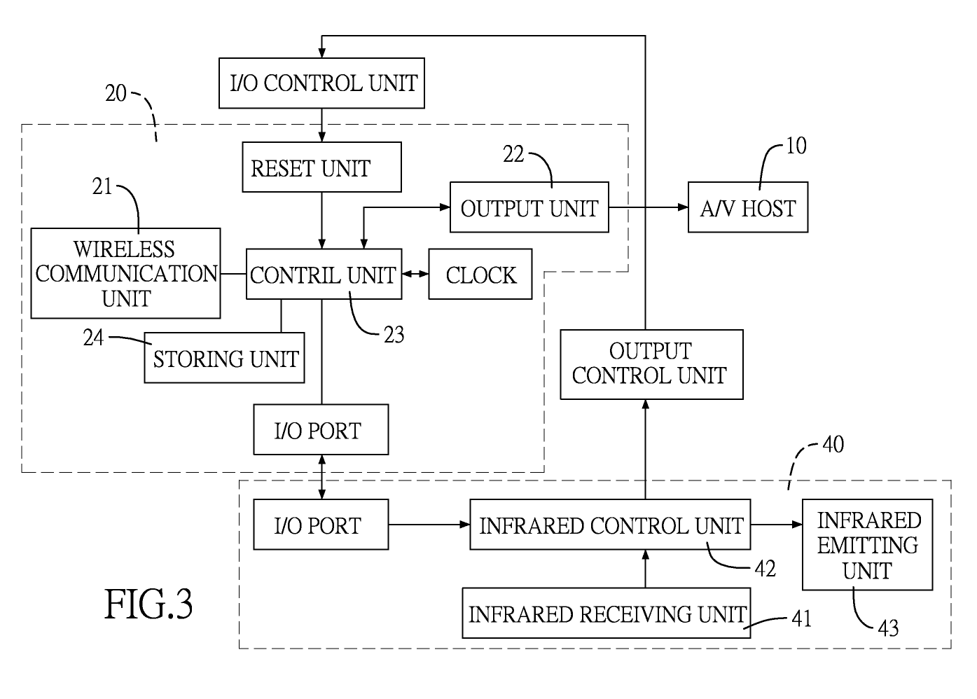

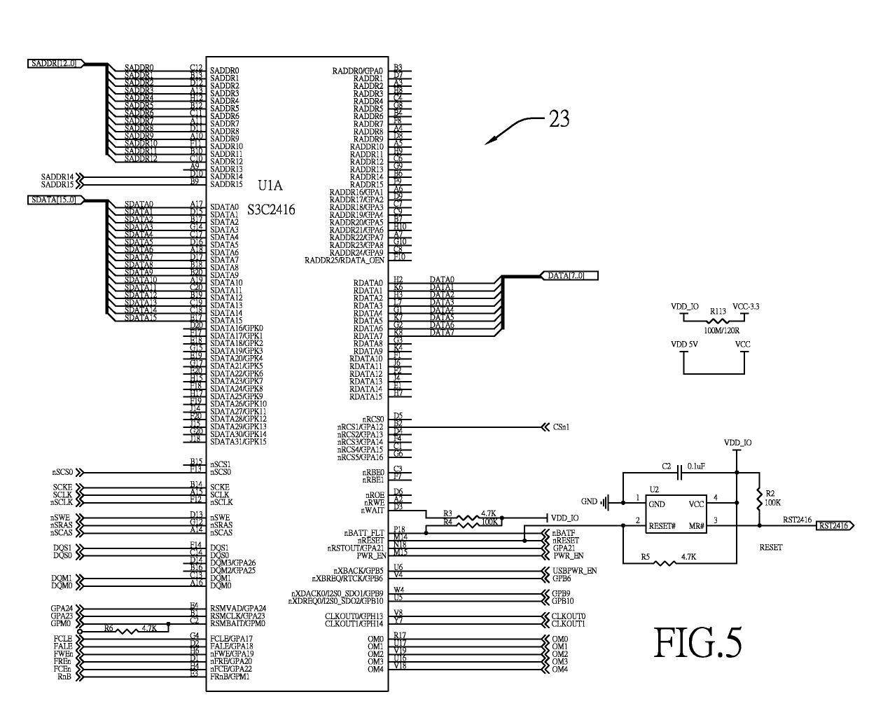

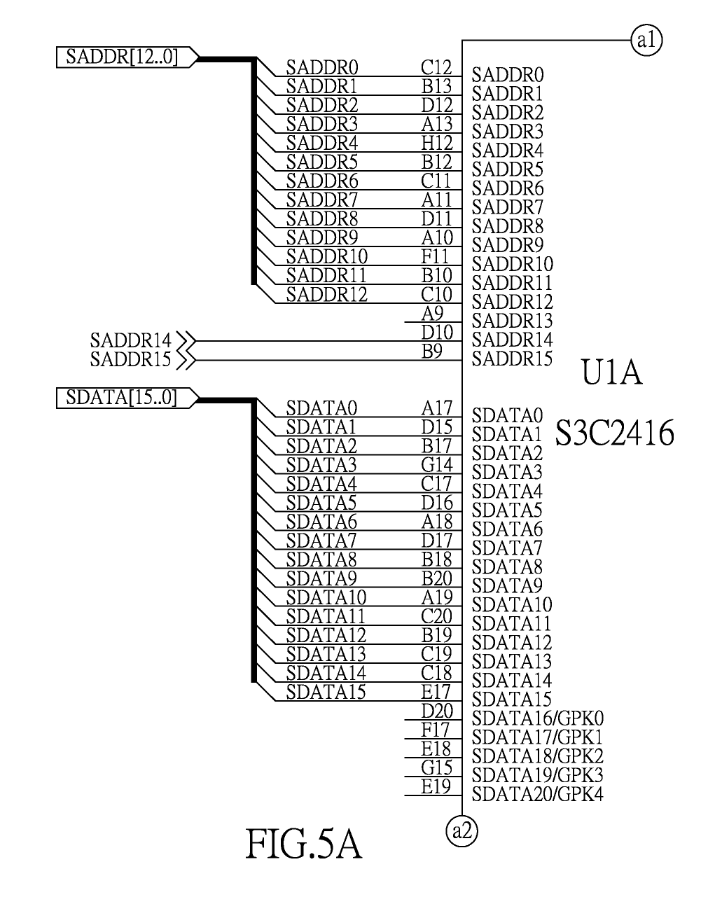

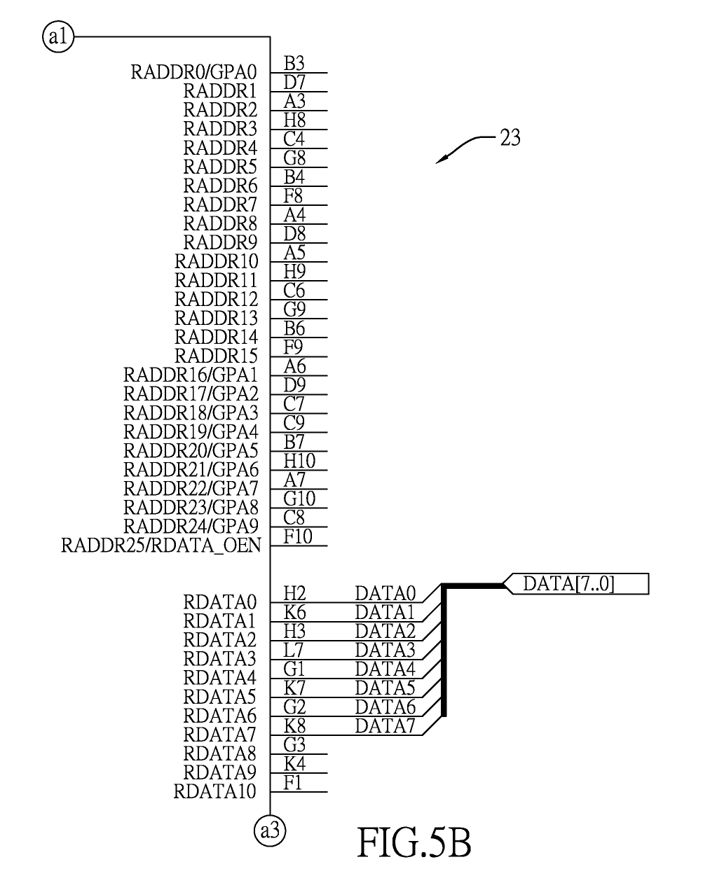

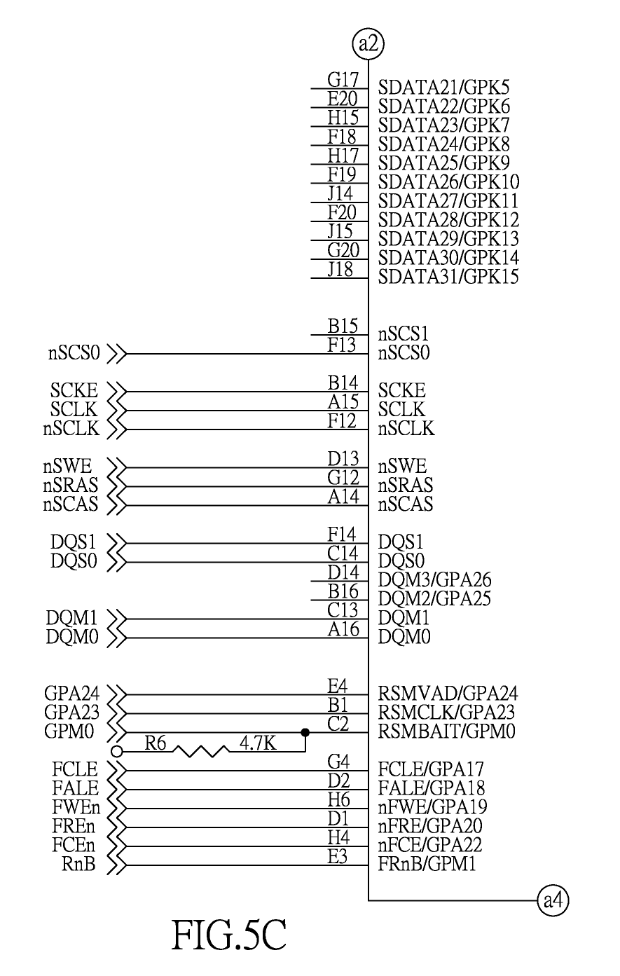

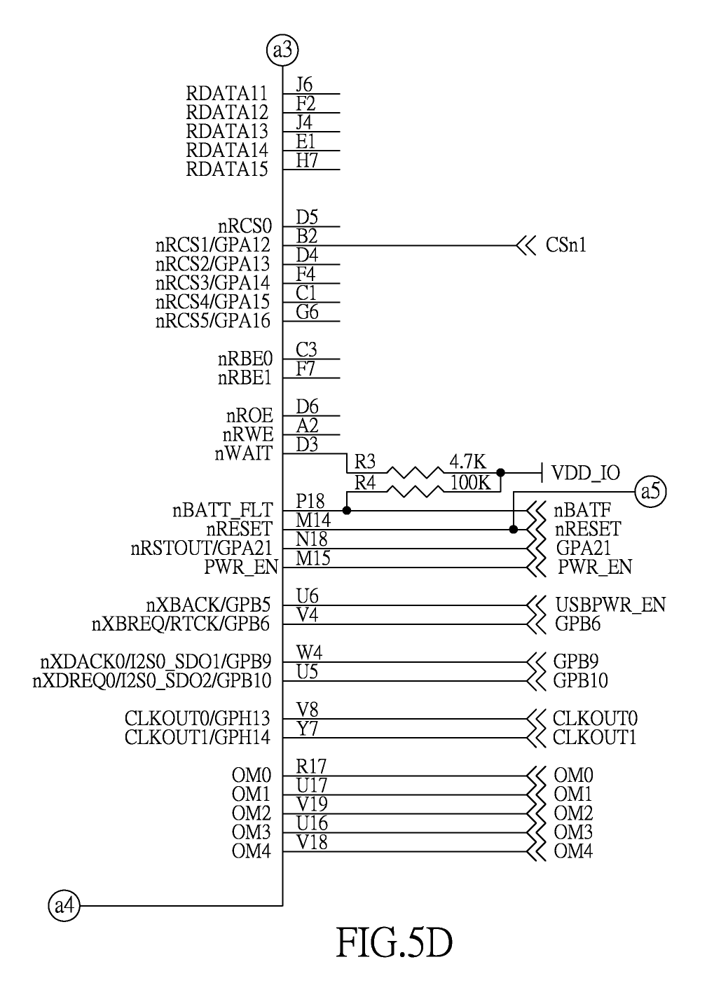

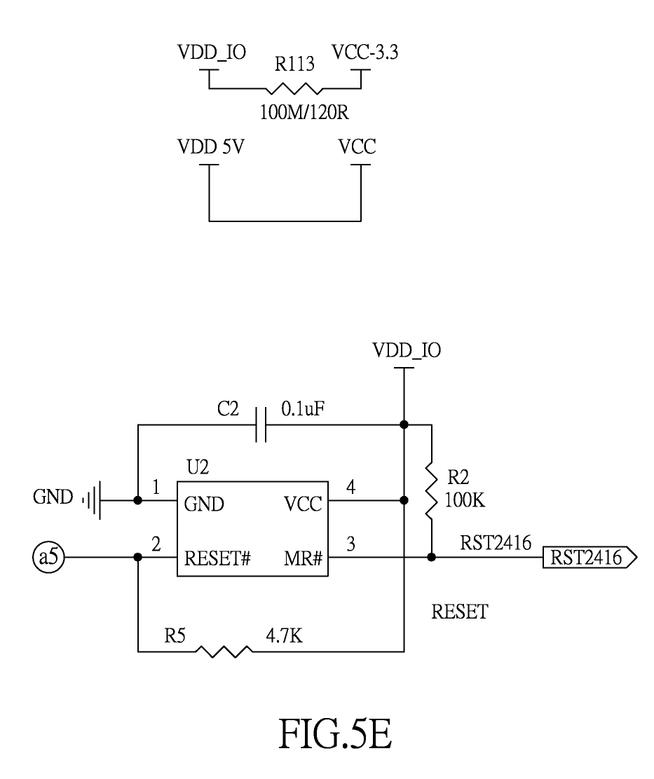

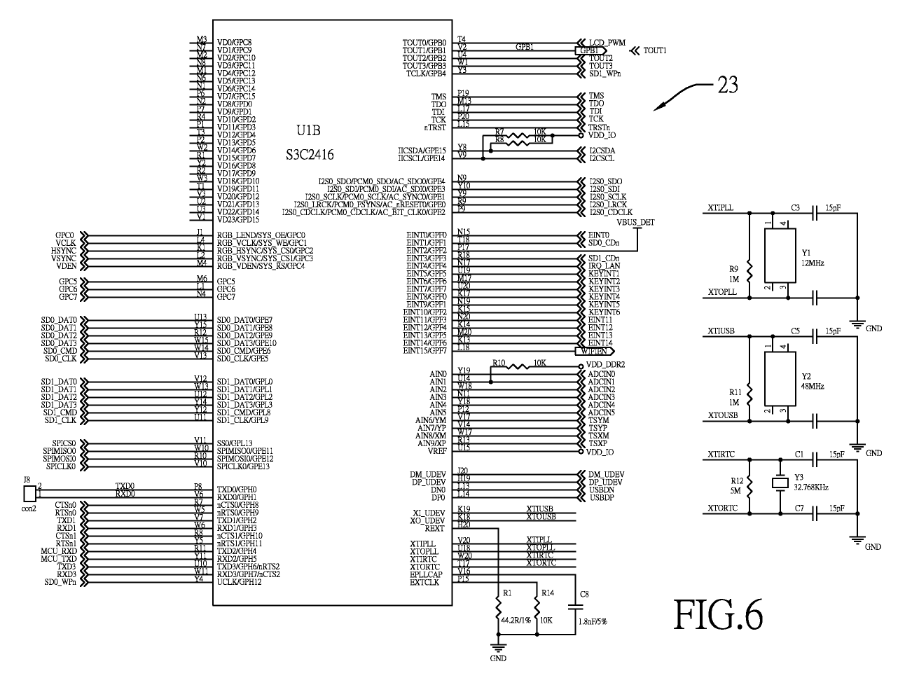

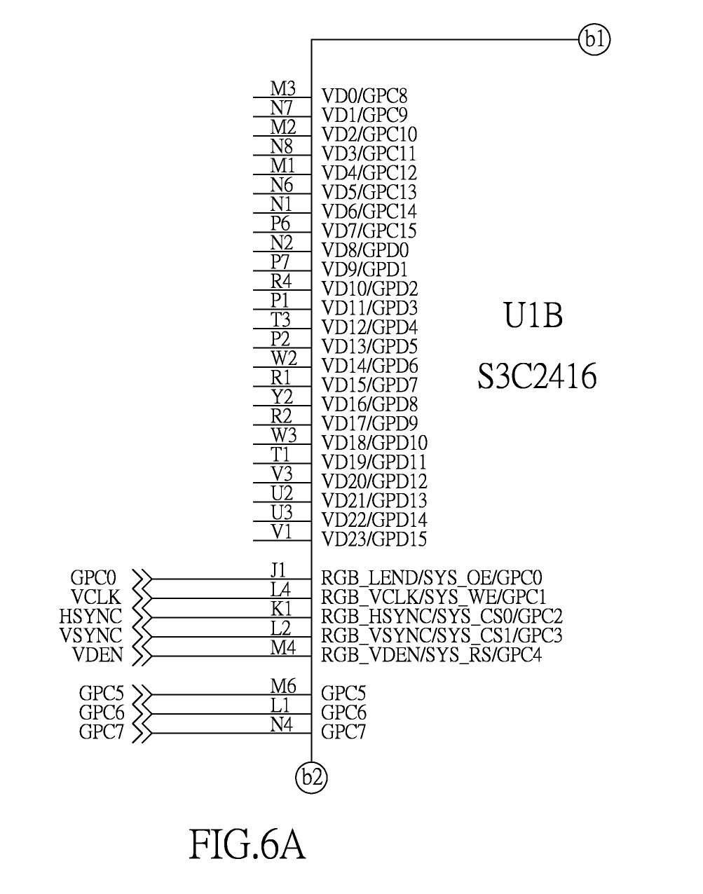

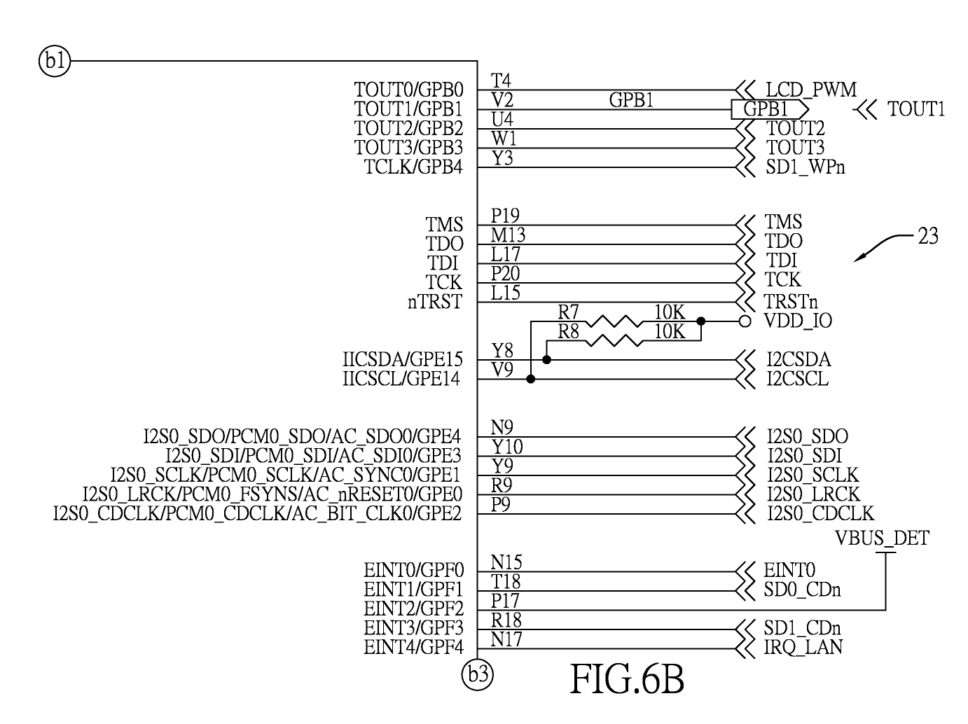

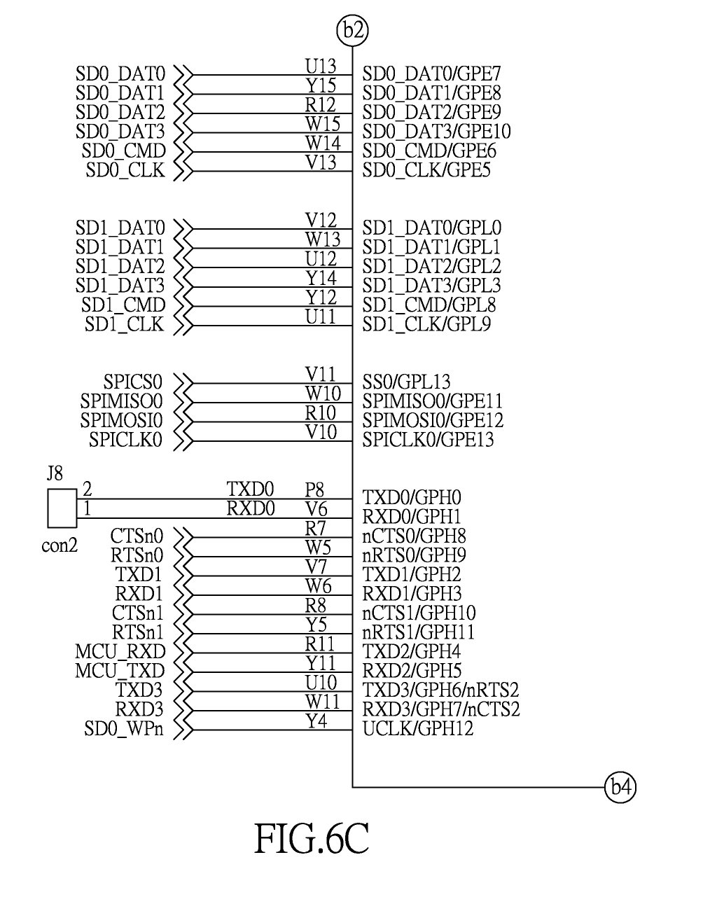

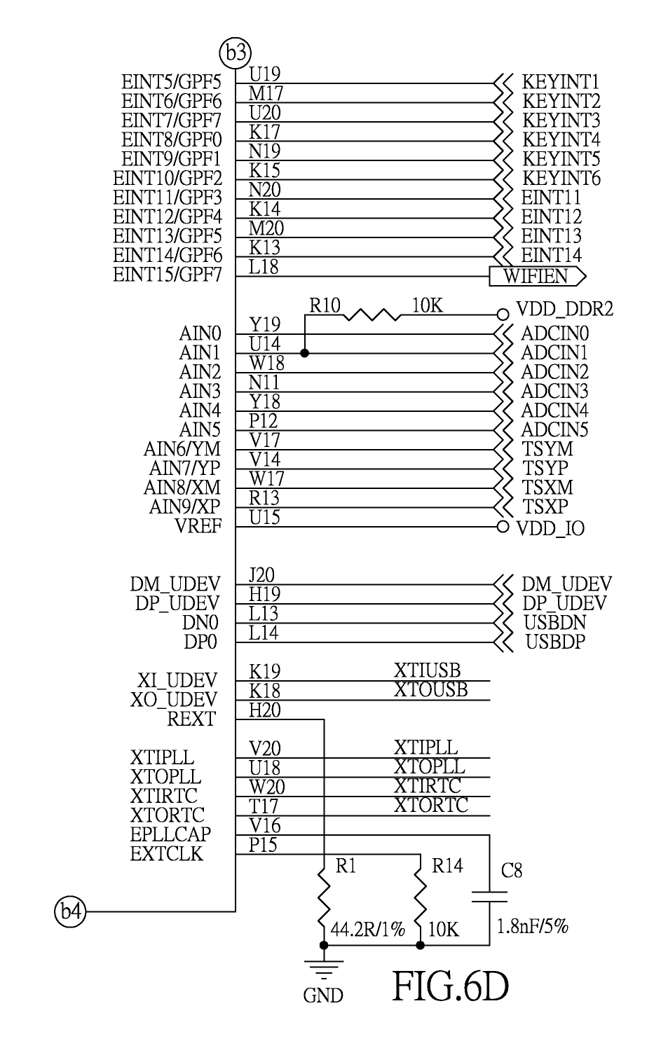

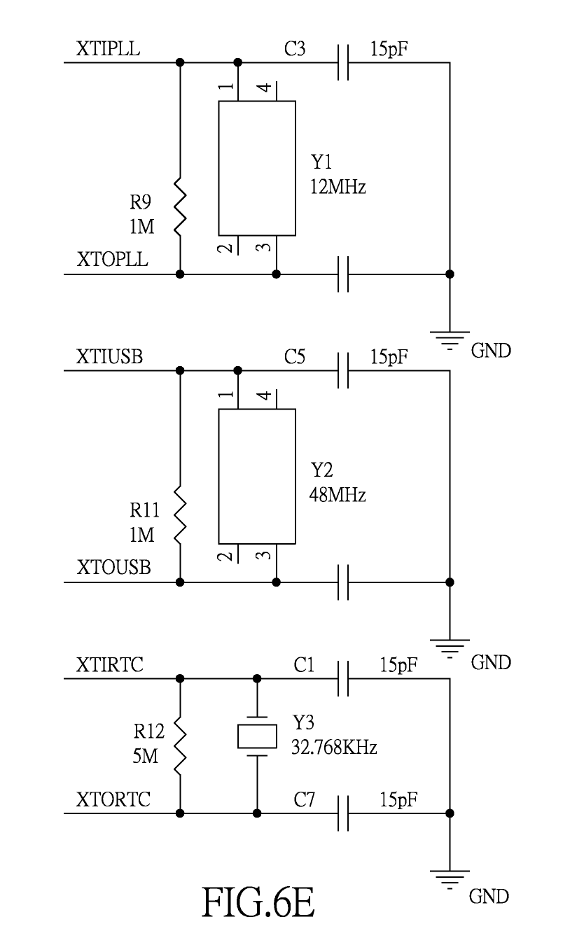

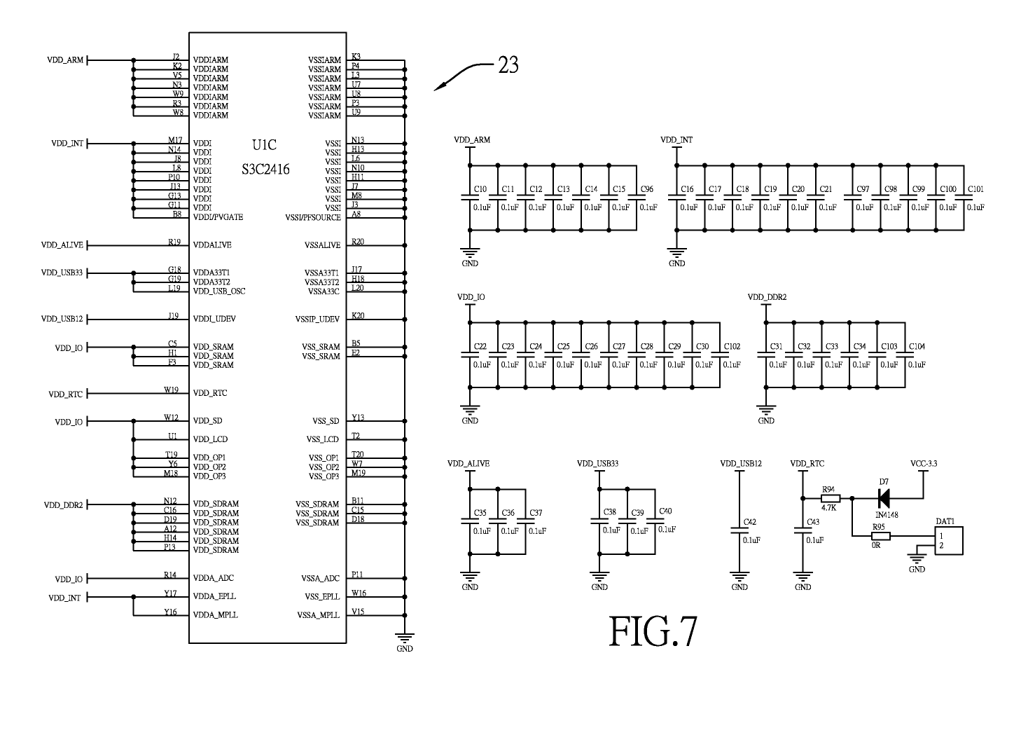

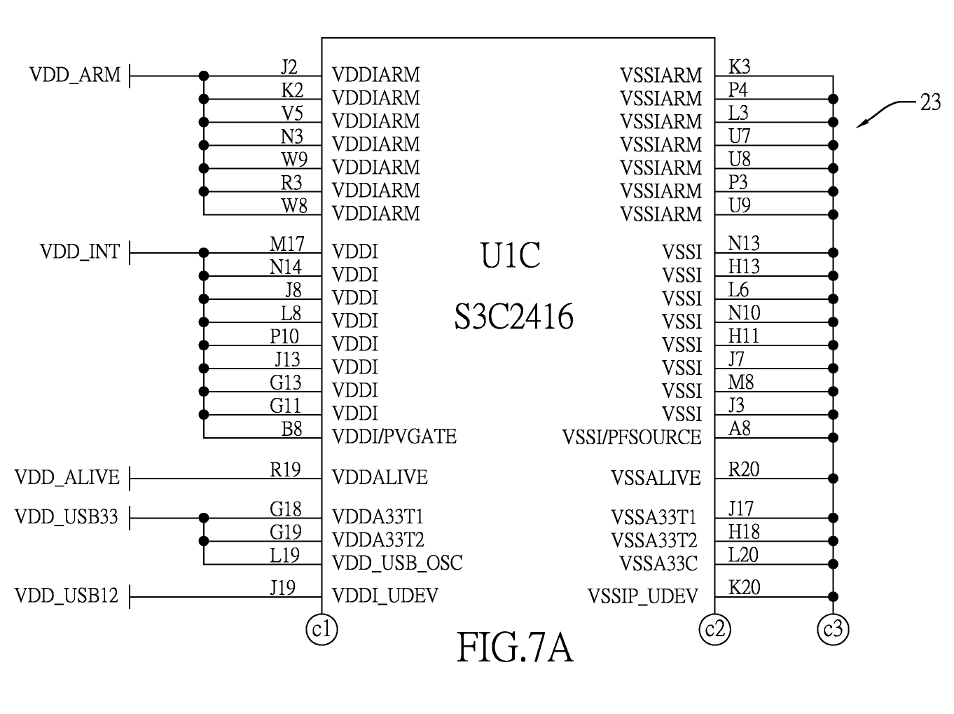

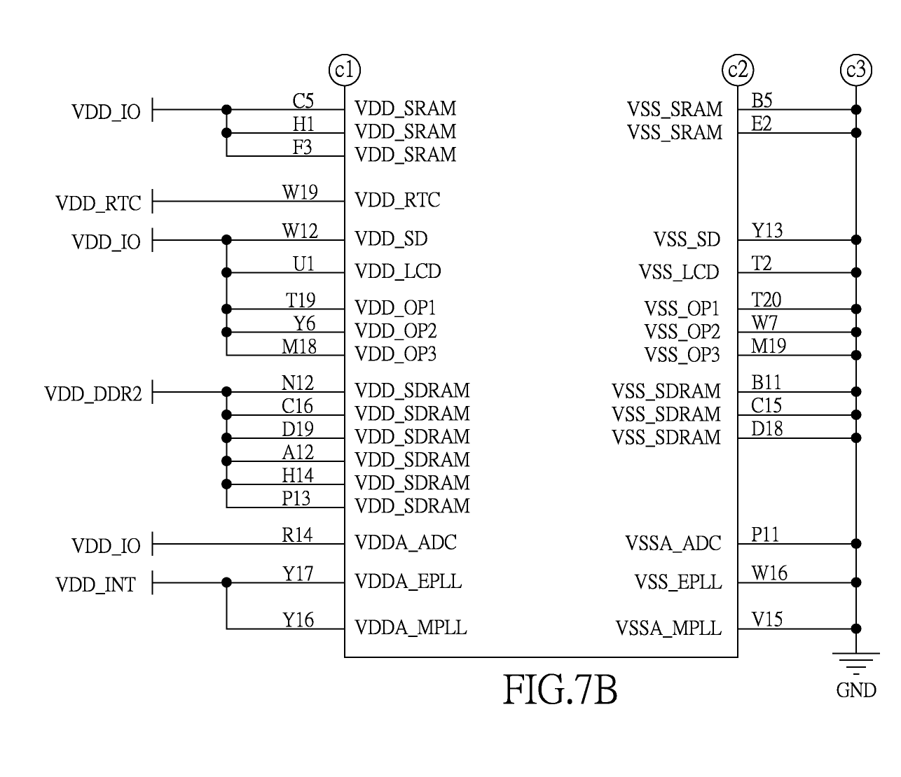

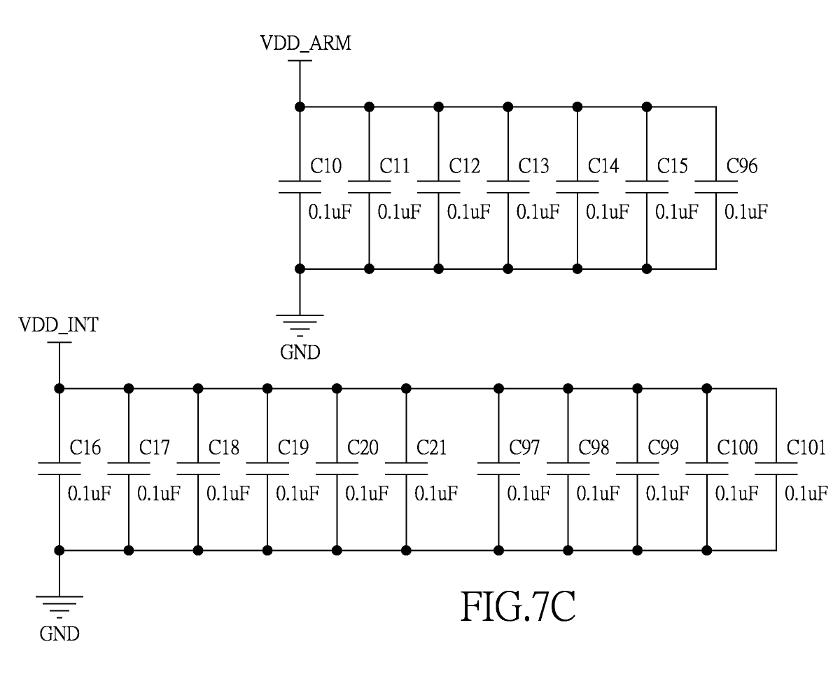

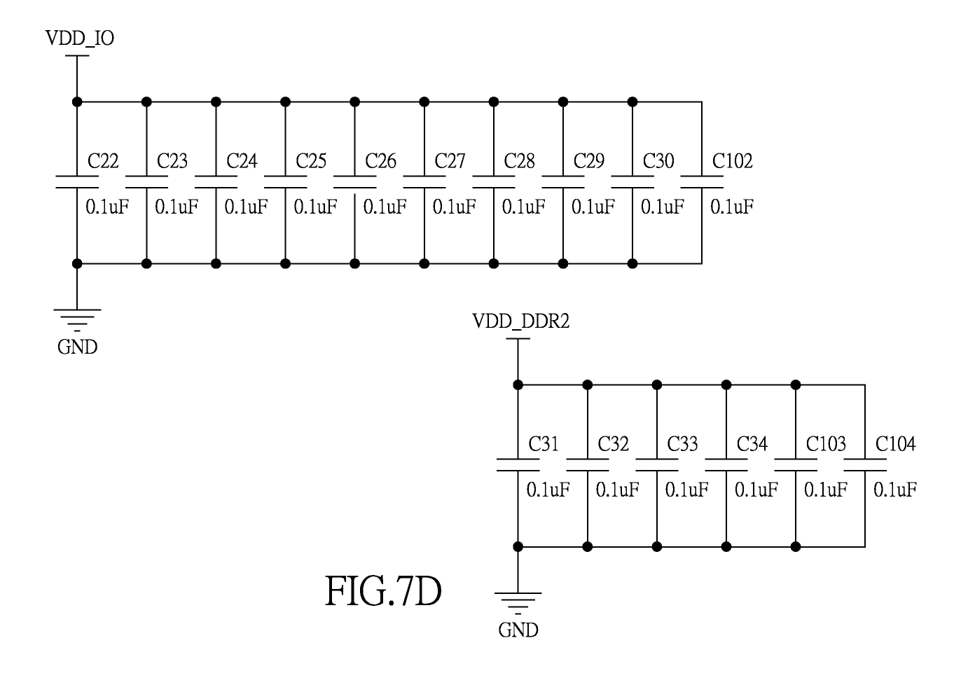

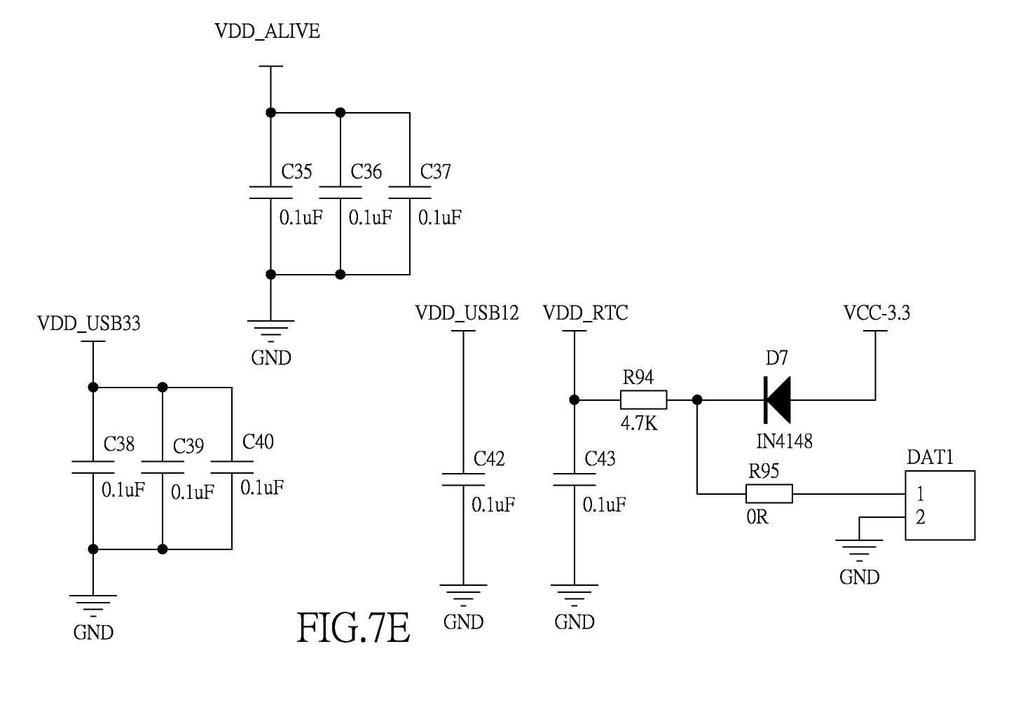

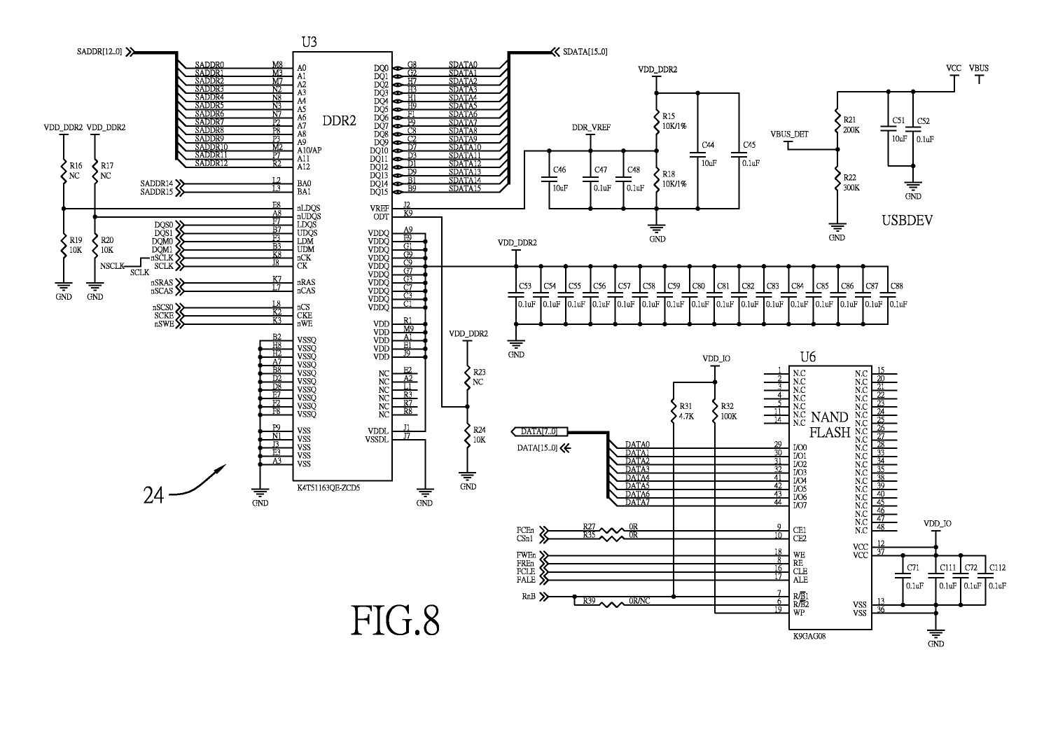

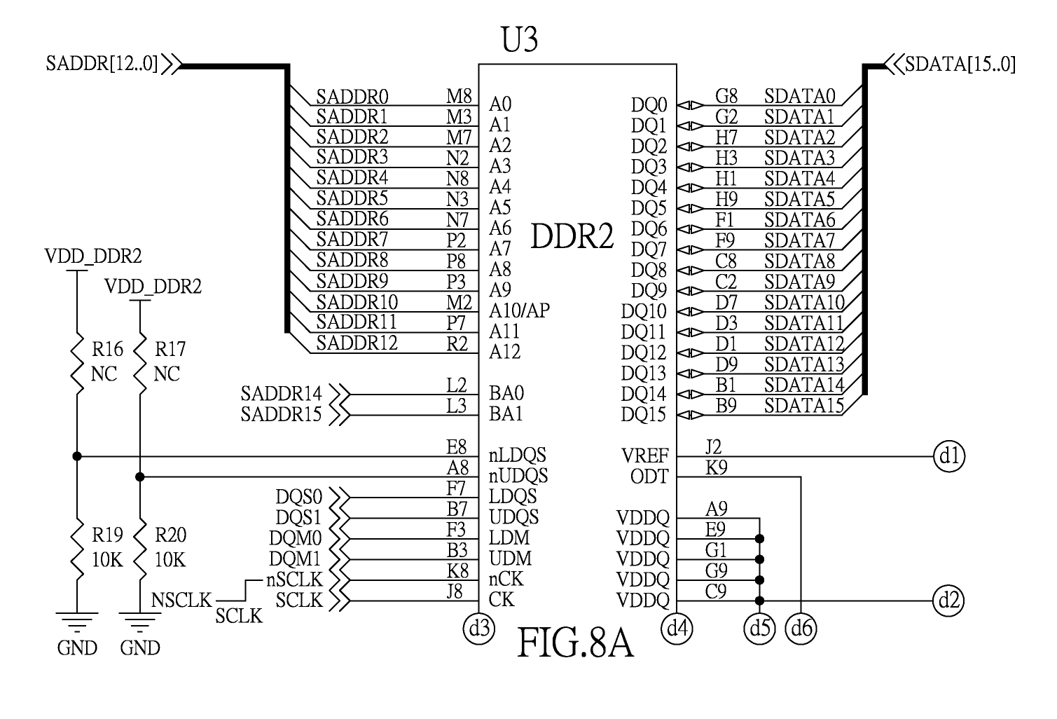

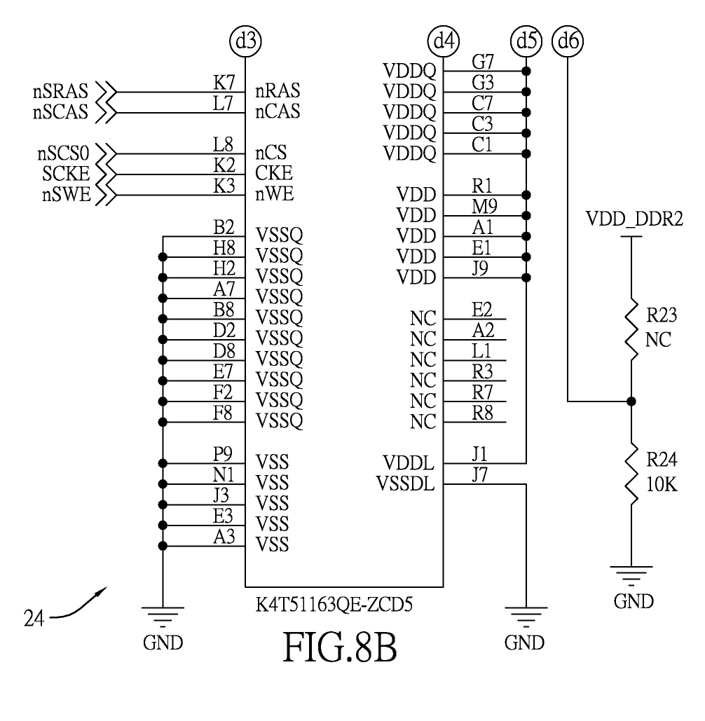

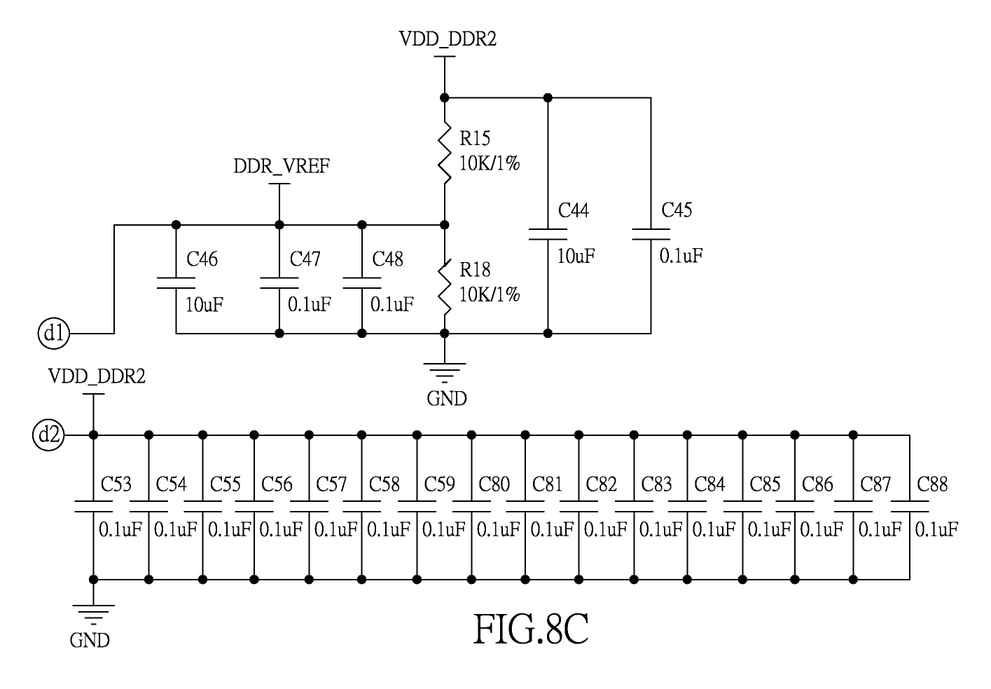

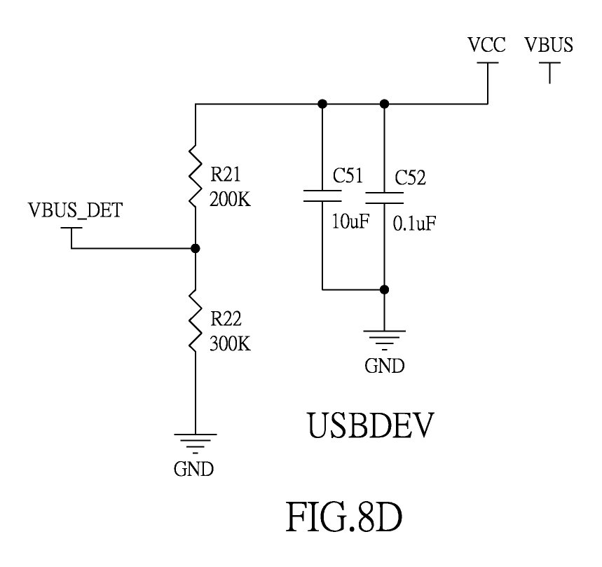

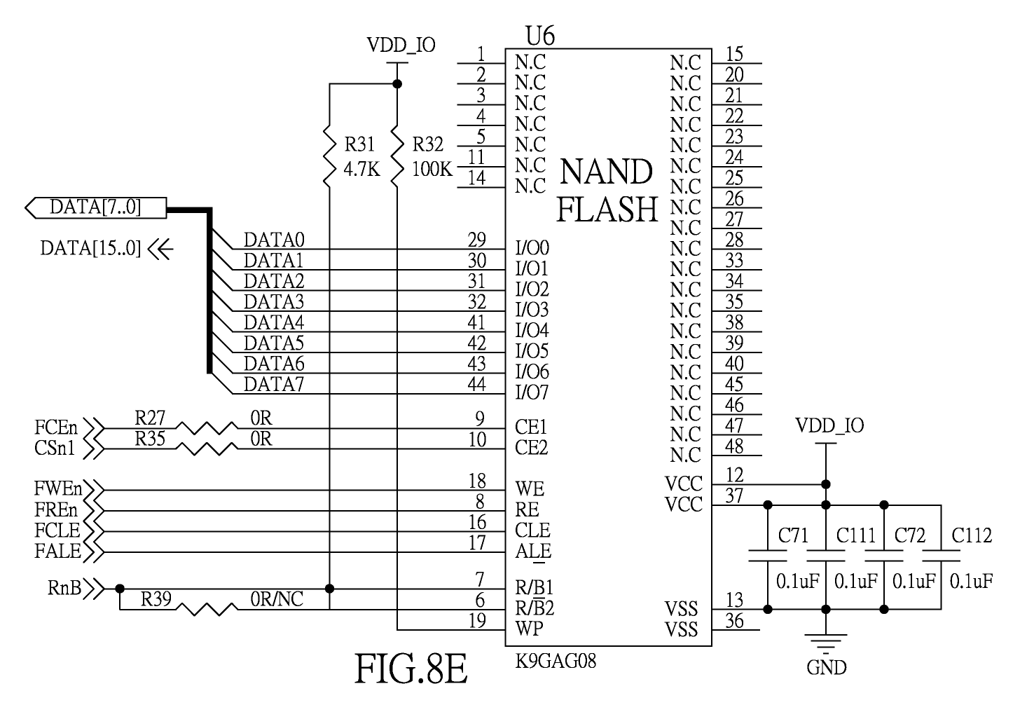

With reference to FIGS. 1 and 3, the control device 20 comprises a wireless communication unit 21, an output unit 22, a control unit 23 and a storing unit 24. With reference to FIGS. 5, 5A-5E, 6, 6A-6E, 7 and 7A-7E, the control unit 23 can be a S3C2416 chip module. A detailed circuit diagram of the storing unit 24 is disclosed in FIGS. 8 and 8A-8E.

The wireless communication unit 21 is connected with multiple user-end apparatuses 30. The wireless communication unit 21 can be, but is not limited to, a Wi-Fi unit. The user-end apparatuses 30 can be smart phones, tablets, personal computers, laptops, displays, etc, wherein such user-end apparatuses 30 have Wi-Fi communication function. The user-end apparatus 30 executes an application (APP) to act as a remote controller, such that the user-end apparatus 30 can send a wireless signal containing an A/V adjusting command to the wireless communication unit 21.

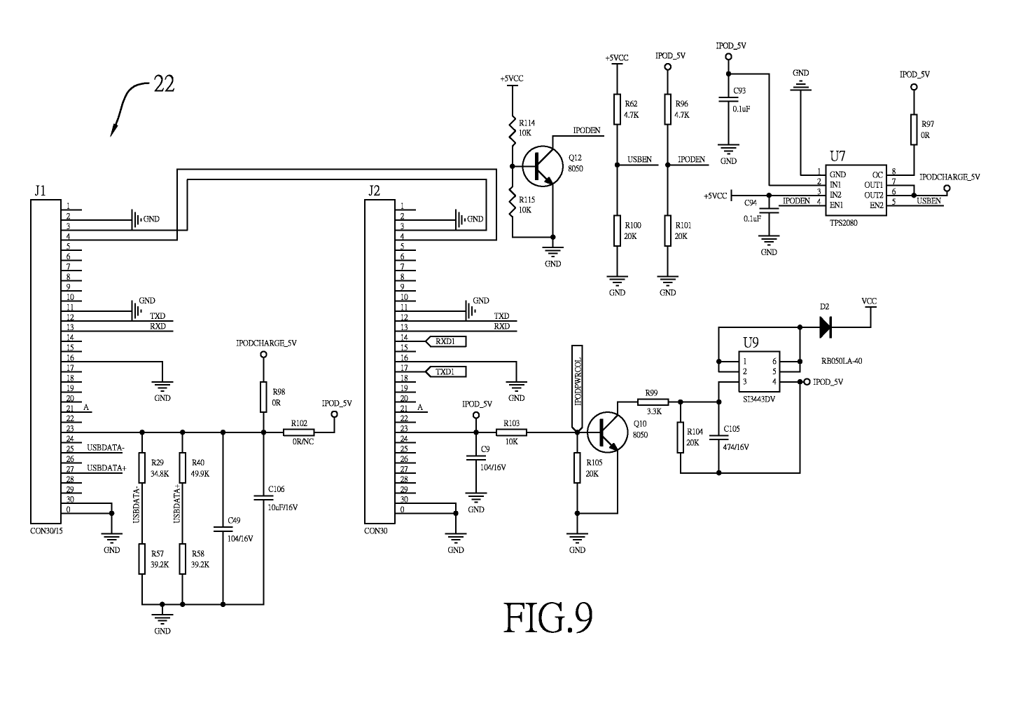

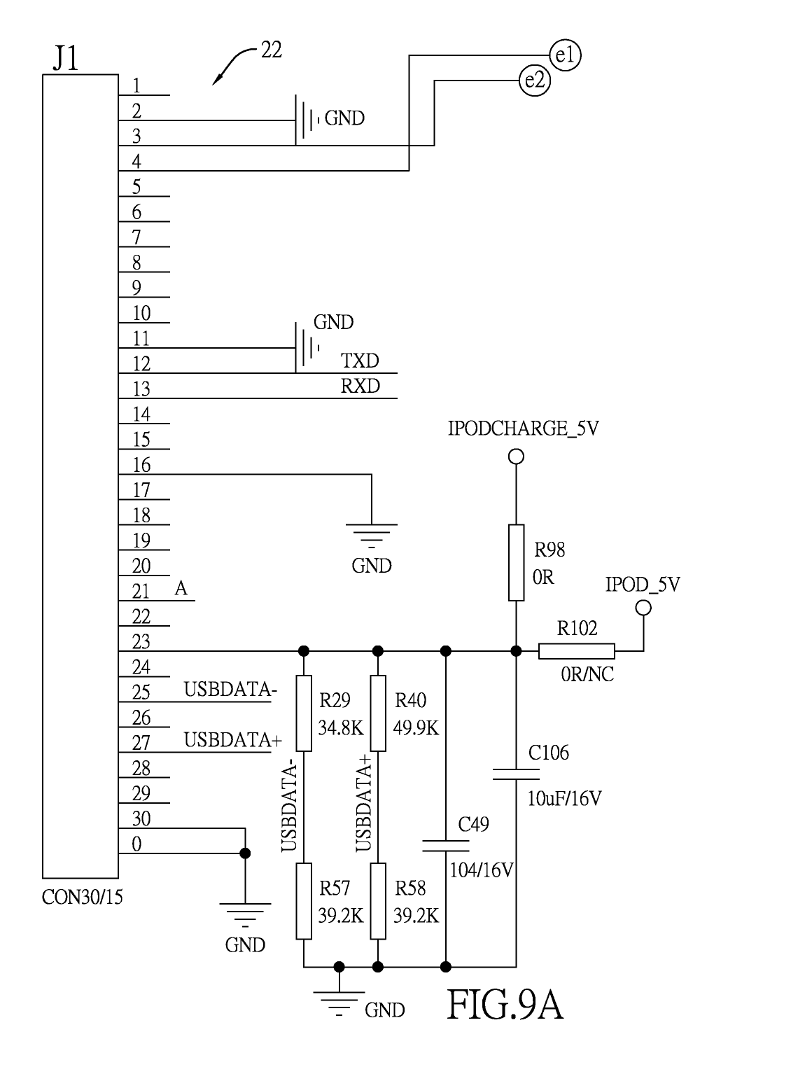

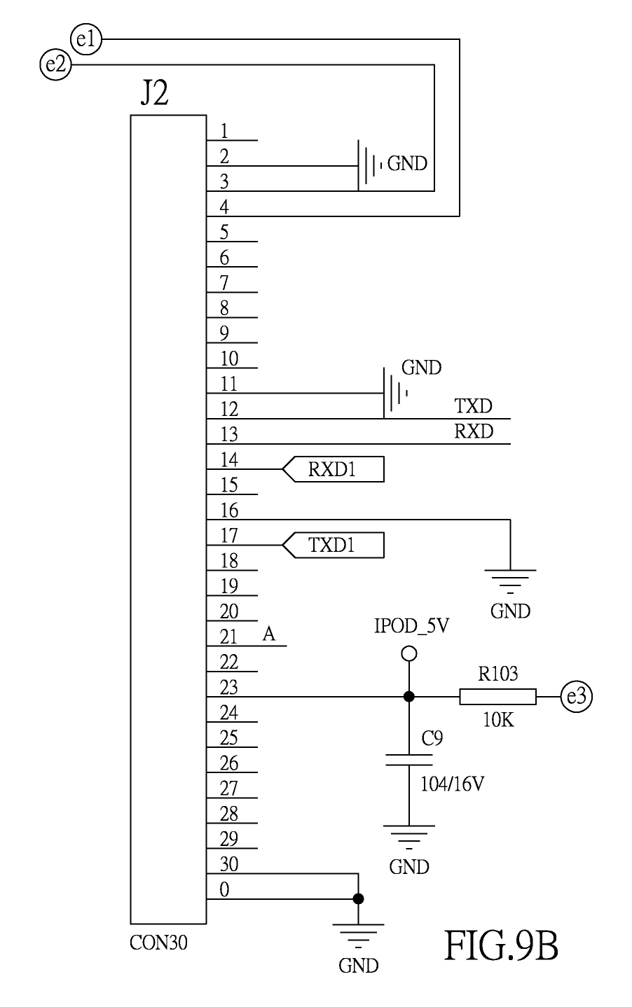

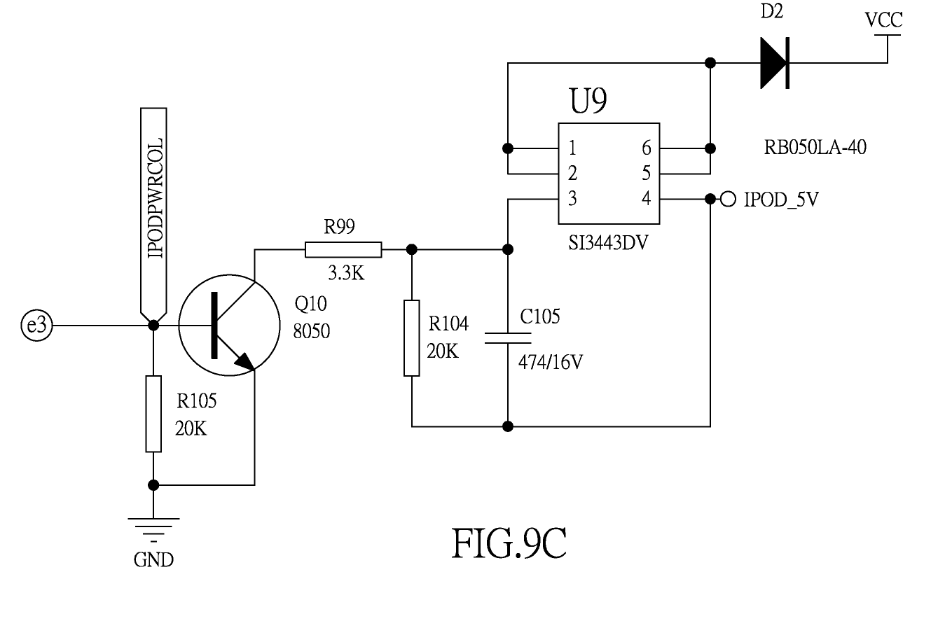

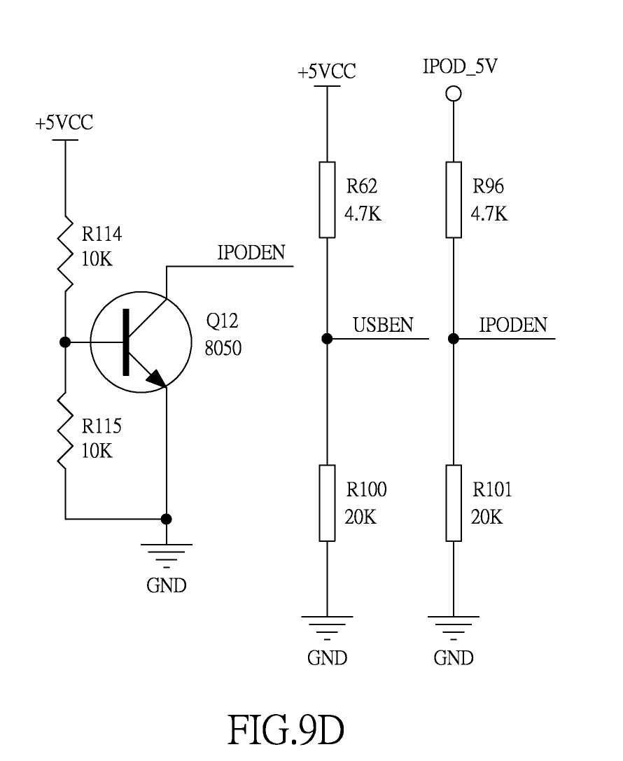

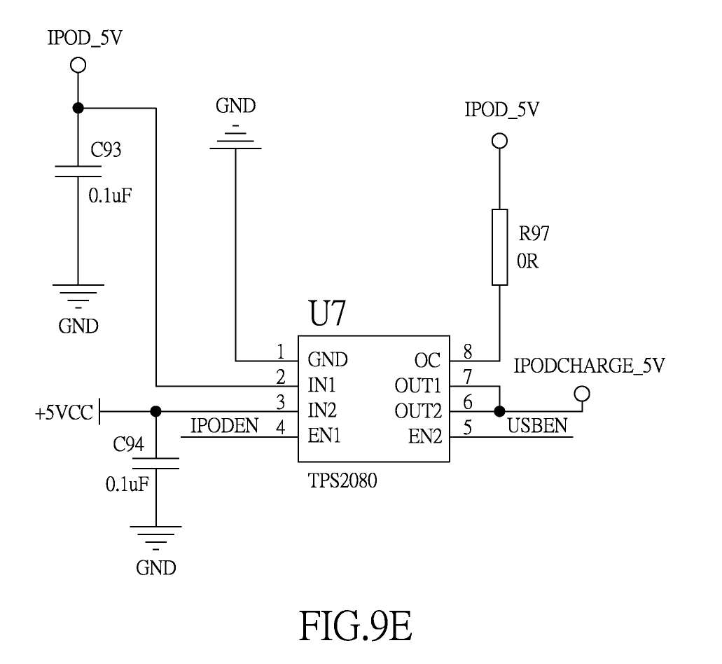

The output unit 22 is connected with the A/V host 10. The output unit 22 can be, but is not limited to, a serial port for being wiredly connected with the A/V host 10. A detailed circuit diagram of the output unit 22 is disclosed in FIGS. 9 and 9A-9E.

The control unit 23 is connected with the wireless communication unit 21, the output unit 22 and the storing unit 24. The control unit 23 receives the wireless signal from any one of the user-end apparatuses 30. When the control unit 23 receives the wireless signal, the control unit 23 updates the A/V information according to the A/V adjusting command of the wireless signal. The A/V host 10 thus controls the sound effect of the amplifier 11 according to the updated A/V information. Meanwhile, the control unit 23 reads the updated A/V information from the A/V host 10 and sends the updated A/V information to all of the user-end apparatuses 30.

Afterwards, when the user-end apparatus 30 executes the application, the user-end apparatus 30 thus displays the updated AN information of the A/V host 10. The user-end apparatuses 30 may be owned by different users. When any user updates the A/V information to the A/V host 10, all of the user-end apparatuses 30 correspondingly display the updated A/V information of the A/V host 10. Hence, all of the users can review the present A/V information of the A/V host 10 in real time.

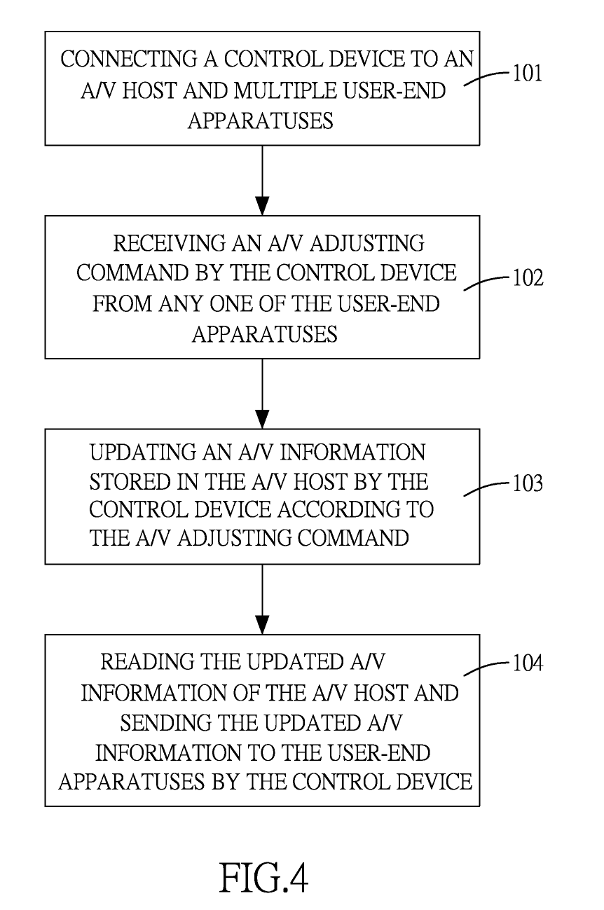

In conclusion, with reference to FIG. 4, an A/V information updating control method of the invention mainly comprises the steps of:

connecting the control device 20 to the A/V host 10 and the user-end apparatuses 30 (step 101);

receiving the A/V adjusting command by the control device 20 from any one of the user-end apparatuses (step 102);

updating the A/V information of the A/V host 10 by the control device 20 according to the A/V adjusting command (step 103); and

reading the updated A/V information of the A/V host 10 by the control device 20 and sending the updated A/V information to the user-end apparatuses 30 (step 104).

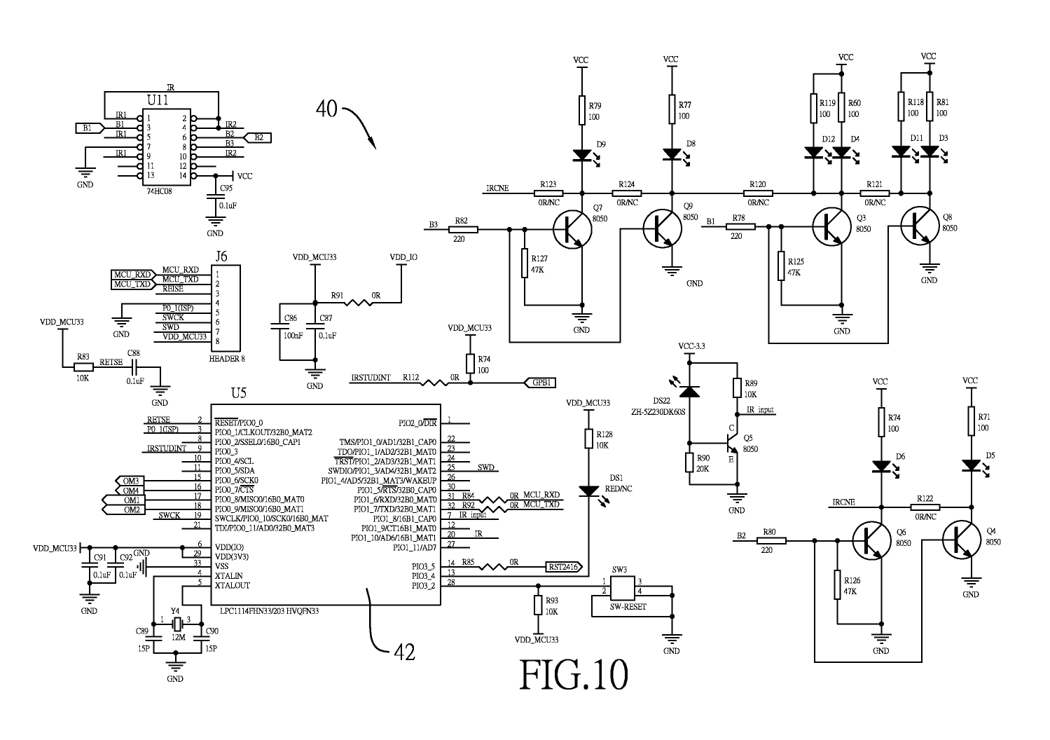

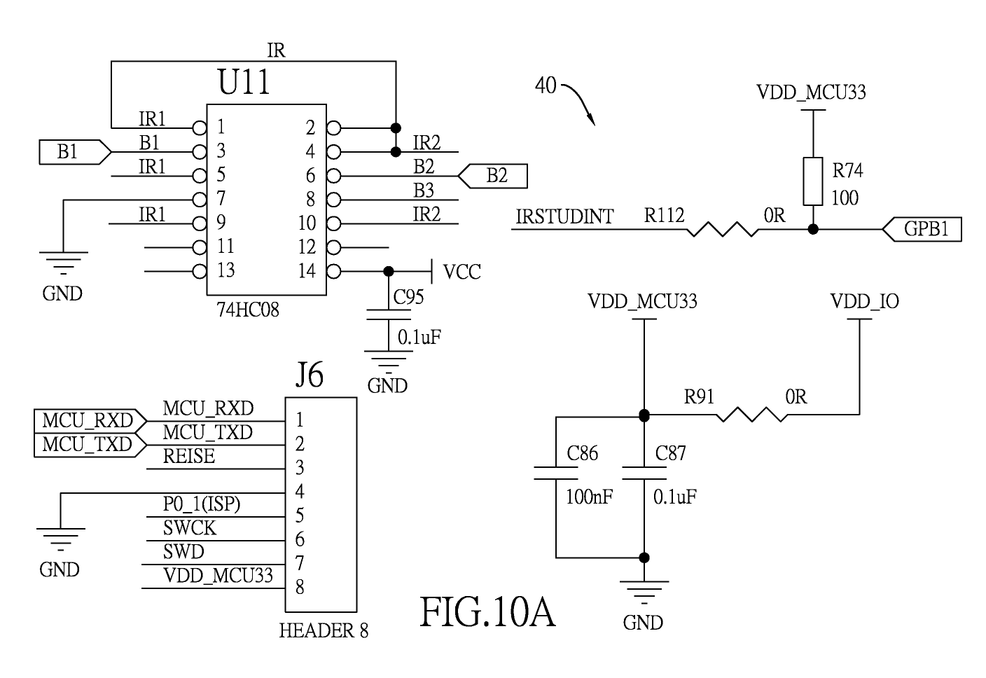

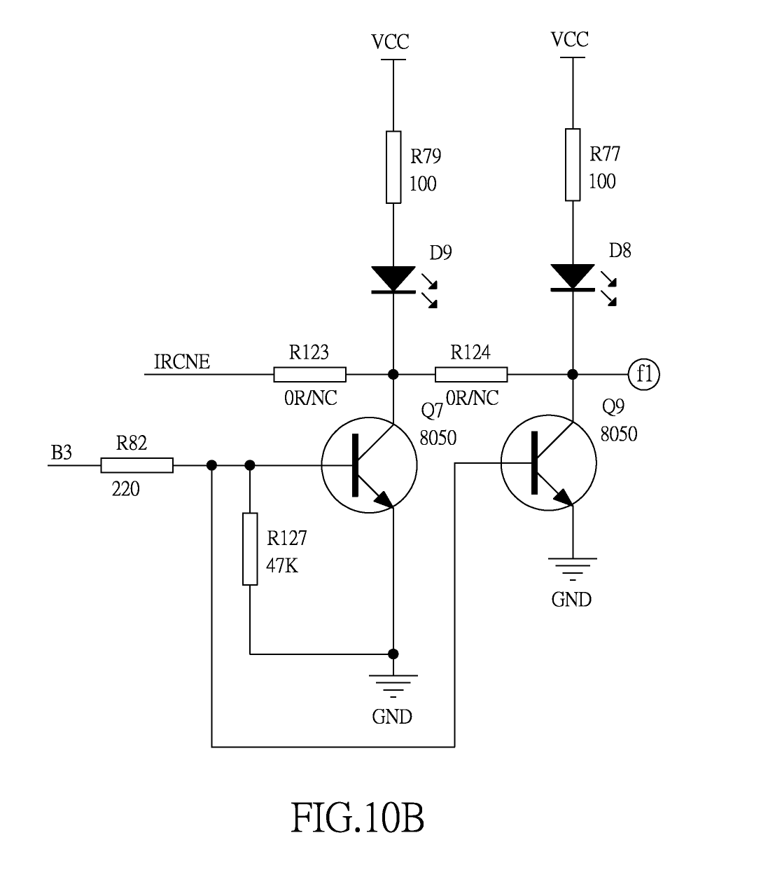

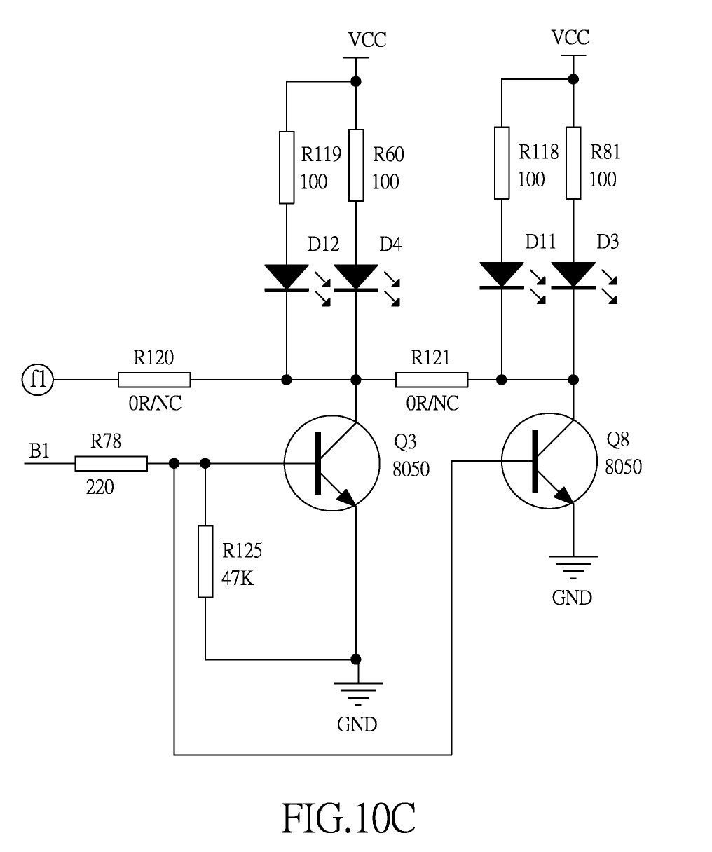

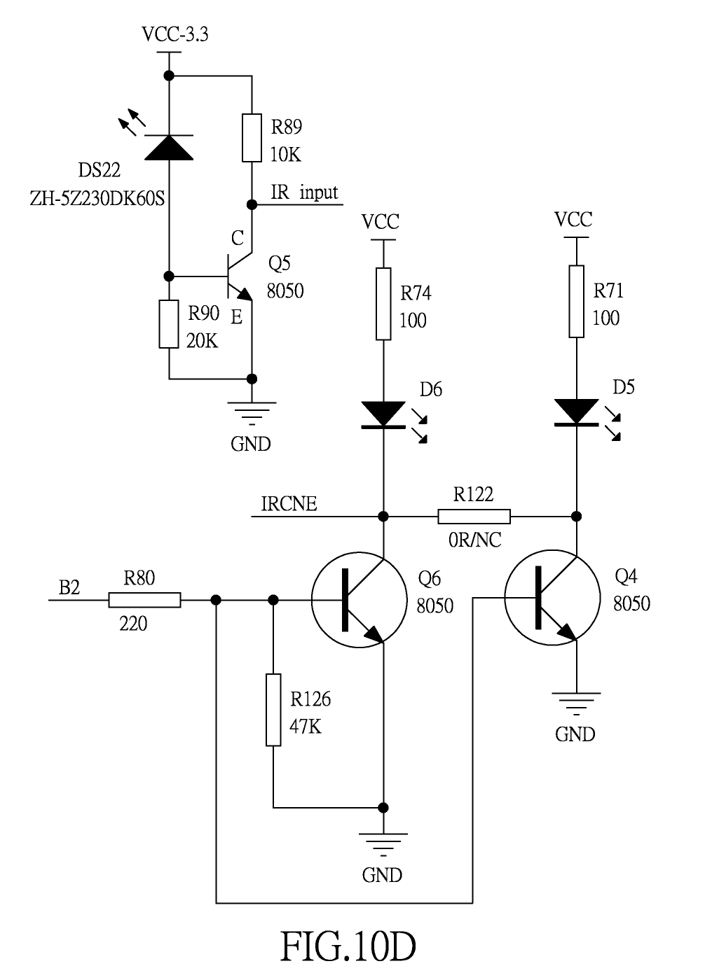

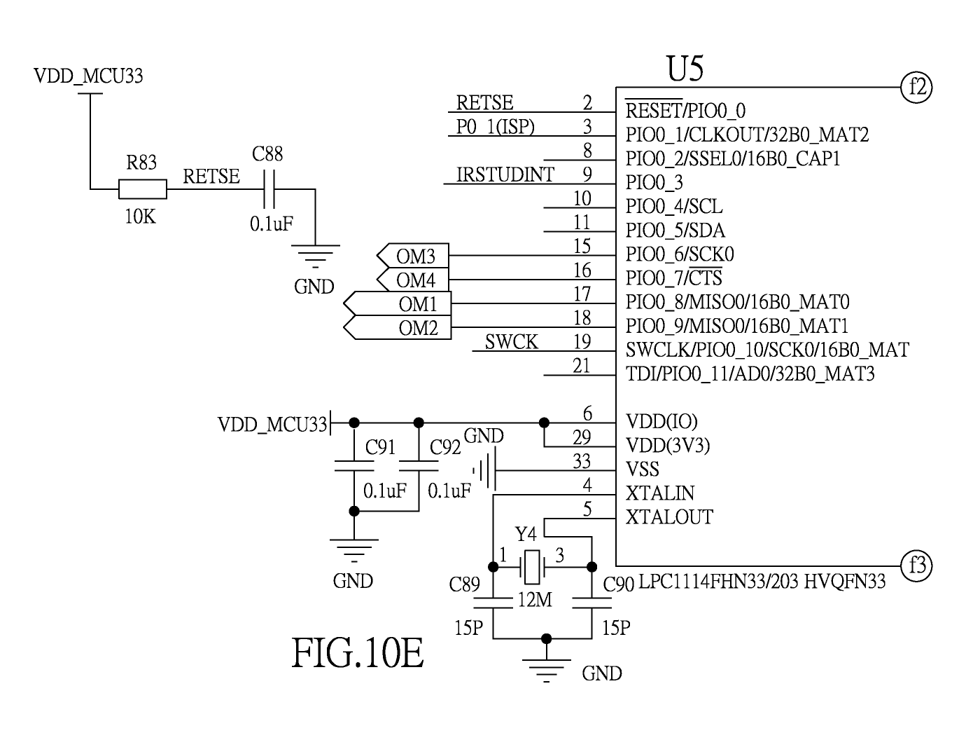

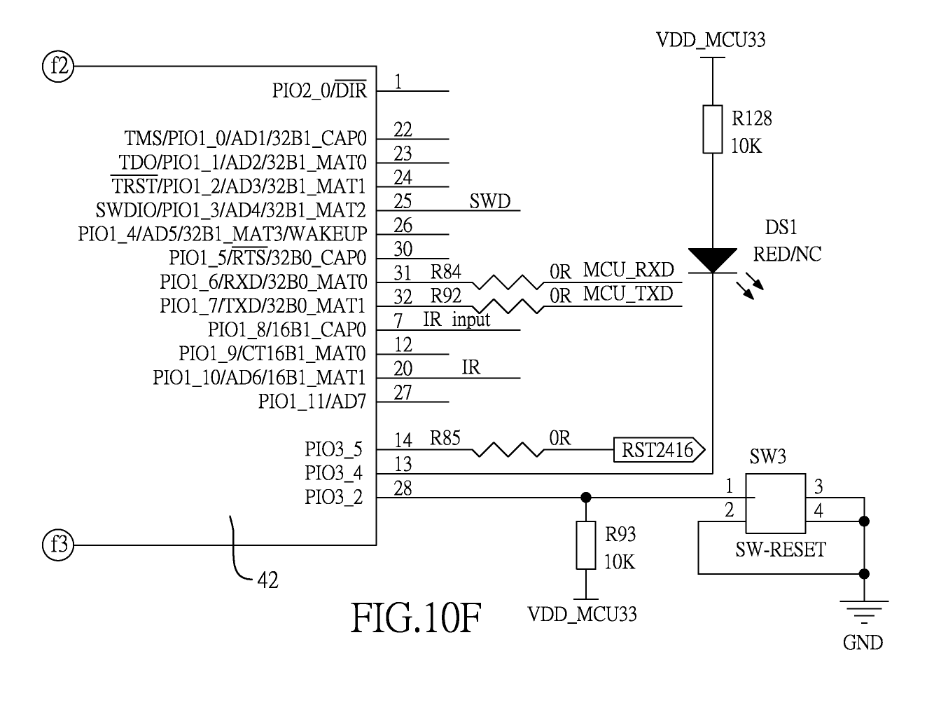

In addition, with reference to FIGS. 1 and 3, the control system of the invention can further comprise an infrared device 40. A detailed circuit diagram of the infrared device 40 is disclosed in FIGS. 10 and 10A-10F. The infrared device 40 is preset with a learning mode, such that each user-end apparatus 30 can control the amplifier 11, the display 12 and the disk player 13 through the infrared device 40. The infrared device 40 is connected with the control device 20 and has an infrared receiving unit 41, an infrared control unit 42 and an infrared emitting unit 43. The infrared control unit 42 is connected with the infrared receiving unit 41, the infrared emitting unit 43, and the control unit 23 of the control device 20.

The user can use the remote controller of the amplifier 11, the display 12 or the disk player 13 to send an infrared control command to the infrared receiving unit 41, such that the infrared control unit 42 receives the infrared control command from the remote controller through the infrared receiving unit 41. The infrared control unit 42 then sends the infrared control command to the control unit 23 of the control device 20 through the infrared emitting unit 43. When the control unit 23 receives the infrared control command, the control unit 23 stores the infrared control command in the storing unit 24.

Hence, the storing unit 24 of the control device 20 stores the infrared control command. When the user operates the user-end apparatus 30 to control the display 12 or the disk player 13, the user-end apparatus 30 sends an operating command to the control unit 23 of the control device 20, wherein the operating command is adapted to control the peripheral devices. When the control unit 23 receives the operating command, the control unit 23 selects the infrared control command from the storing unit 24 according to the operating command and sends the infrared control command to the infrared control unit 42. When the infrared control unit 42 receives the infrared control command from the control device 20, the infrared control unit 42 sends the infrared control command to the display 12 or the disk player 13 through the infrared emitting unit 43 to control the display 12 or the disk player 13.

Hence, the user can use the smart phone or the tablet to control the display 12 or the disk player 13 by using the infrared control commands, instead of using the dedicated remote controllers. It is convenient to control peripheral devices by using the control device 20 of the invention.

What is claimed is:

1. An A/V (audio and video) information updating control system adapted to be connected with multiple user-end apparatuses and comprising:
an A/V host storing an A/V information; and
a control device comprising:
a wireless communication unit connected with the user-end apparatuses to receive an A/V adjusting command from any one of the user-end apparatuses;
an output unit connected with the A/V host; and
a control unit connected with the wireless communication unit and the output unit, wherein the control unit receives the A/V adjusting command from the wireless communication unit, updates the A/V information of the A/V host according to the A/V adjusting command, reads the updated A/V information of the A/V host and sends the updated A/V information to the user-end apparatuses.

2. The control system as claimed in claim 1, wherein the wireless communication unit of the control device is a Wi-Fi unit receiving a wireless signal containing the A/V adjusting command from the user-end apparatus.

3. The control system as claimed in claim 1, wherein the output unit of the control device is a serial port.

4. The control system as claimed in claim 1 further comprising an infrared device, wherein
the control device has a storing unit connected with the control unit of the control device; and
the infrared device is connected with the control device and comprises:
an infrared receiving unit;
an infrared emitting unit; and
an infrared control unit connected with the infrared receiving unit, the infrared emitting unit, and the control unit of the control device; the infrared control unit receiving an infrared control command from the infrared receiving unit and sending the infrared control command to the control unit of the control device through the infrared emitting unit, such that the control unit of the control device stores the infrared control command in the storing unit when the control unit of the control device receives the infrared control command.

5. The control system as claimed in claim 2 further comprising an infrared device, wherein
the control device has a storing unit connected with the control unit of the control device; and
the infrared device is connected with the control device and comprises:
an infrared receiving unit;
an infrared emitting unit; and
an infrared control unit connected with the infrared receiving unit, the infrared emitting unit, and the control unit of the control device; the infrared control unit receiving an infrared control command from the infrared receiving unit and sending the infrared control command to the control unit of the control device through the infrared emitting unit, such that the control unit of the control device stores the infrared control command in the storing unit when the control unit of the control device receives the infrared control command.

6. The control system as claimed in claim 3 further comprising an infrared device, wherein
the control device has a storing unit connected with the control unit of the control device; and
the infrared device is connected with the control device and comprises:
an infrared receiving unit;
an infrared emitting unit; and
an infrared control unit connected with the infrared receiving unit, the infrared emitting unit, and the control unit of the control device; the infrared control unit receiving an infrared control command from the infrared receiving unit and sending the infrared control command to the control unit of the control device through the infrared emitting unit, such that the control unit of the control device stores the infrared control command in the storing unit when the control unit of the control device receives the infrared control command.

7. The control system as claimed in claim 1, wherein the A/V information includes sound tune, sound volume and equalization.

8. A control device of an A/V information updating control system, the control device adapted to be connected with multiple user-end apparatuses and an A/V host and comprising:
a wireless communication unit connected with the user-end apparatuses to receive an A/V adjusting command from any one of the user-end apparatuses;
an output unit connected with the A/V host; and
a control unit connected with the wireless communication unit and the output unit, wherein the control unit receives the A/V adjusting command from the wireless communication unit, updates an A/V information stored in the A/V host according to the A/V adjusting command, reads the updated A/V information of the A/V host and sends the updated A/V information to the user-end apparatuses.

9. The control device as claimed in claim 8, wherein the wireless communication unit is a Wi-Fi unit receiving a wireless signal containing the A/V adjusting command from the user-end apparatus.

10. The control device as claimed in claim 8, wherein the output unit is a serial port.

11. The control device as claimed in claim 8 further comprising a storing unit connected with the control unit, wherein the control unit receives an infrared control command and stores the infrared control command in the storing unit.

12. The control device as claimed in claim 9 further comprising a storing unit connected with the control unit, wherein the control unit receives an infrared control command and stores the infrared control command in the storing unit.

13. The control device as claimed in claim 10 further comprising a storing unit connected with the control unit, wherein the control unit receives an infrared control command and stores the infrared control command in the storing unit.

14. The control system as claimed in claim 8, wherein the A/V information includes sound tune, sound volume and equalization.

15. A control method of an A/V information updating control system, the control method comprising the steps of:
connecting a control device to an A/V host and multiple user-end apparatuses;
receiving an A/V adjusting command by the control device from any one of the user-end apparatuses;
updating an A/V information stored in the A/V host by the control device according to the A/V adjusting command;
reading the updated A/V information of the A/V host by the control device; and
sending the updated A/V information to the user-end apparatuses by the control device.
